(19) United States
(12) Patent Application Publication
(10) Pub. No.: US 2022/0349157 A1
(43) Pub. Date: Nov. 3, 2022

(54) APPARATUS FOR COLLECTING AND DISPENSING FLUID

(71) Applicant: Paul Anthony BROWN, Trenton (CA)

(72) Inventor: Paul Anthony BROWN, Trenton (CA)

(21) Appl. No.: 17/306,359

(22) Filed: May 3, 2021

(51) Int. Cl. E03B 3/03; B05B 9/08; B67D 7/02; B05B 11/00

(52) U.S. Cl. CPC E03B 3/03; B05B 9/0861; B67D 7/0294; B05B 11/0097

(57) ABSTRACT

An apparatus for collecting and dispensing fluid is disclosed. The apparatus comprises of a main barrel comprising a primary reservoir for collecting and storing fluid and a secondary unit comprising of a secondary reservoir for storing and dispensing fluid. The main barrel defines a space for receiving the secondary unit and the secondary unit is configured to be operably docked in the space defined by the main barrel. The secondary unit when docked to the main barrel, the main barrel and the secondary unit are coupled to receive fluid from the primary reservoir of the main barrel into the secondary reservoir of the secondary unit.

### BACKGROUND

### Field of Invention

The disclosed subject matter relates to the field of rainwater harvesting. More particularly, but not exclusively, the subject matter relates to an apparatus for collecting and dispensing rainwater.

### Discussion of Prior Art

With the ever-growing population, demand for water has been on rise. Potable water has been scarce in few places as the demand is exponentially on the rise and the supply is unable to meet with the demand. Water is not only required for domestic requirements, but also for industrial and commercial needs. Industries, hotels and households, among others require water on daily basis. Furthermore, with the water shortage, cost of water supply is proportionally increasing. With water consumption and water conservation becoming a significantly heightened societal concern, there has been a growing effort to utilize our water resources in a more sustainable manner.

One of the methods employed is rainwater harvesting, wherein during rains, the rainwater is collected and stored for future use. Rainwater harvesting plays an important role in places which experience annual droughts. Many methods are employed for rainwater harvesting. The water harvested from the rainwater could be employed in many different ways including gardening and farming, among others. Domestic rainwater harvesting is one of the efficient methods of rainwater harvesting, wherein a household can adopt a system for collecting and reusing the collected rainwater. The collected rainwater could be used for backyard gardening or farming. Water harvesting devices or rain barrels, have been around for years and the purpose of these devices is quite simple: capturing and storing water for future use. As interest has grown in home gardening and locally grown food, consumers seek alternative ways to offset rising water costs, so has the popularity and interest in installing rain barrels. The term rain barrel means any above-ground or below ground vessel capable of collecting and storing rainwater. To receive significant adoption, rain barrels must be safe, convenient to use and allow the user to more effectively and efficiently carry out certain outdoor household tasks that may require the use of the rainwater. However, the rainwater harvesting systems or apparatus currently available in the markets have several drawbacks.

One environmentally or eco-friendly solution has been the promotion and proliferation of the residential, multi-residential and commercial use of rain barrels. A typical residential building can collect 500 litres of water with just two millilitres of rain, but a consistent challenge for the end user is how to practically transport the rainwater for use, given the weight of the water that is collected in conventional rain barrels. Physically transporting or carrying the conventional rain barrel to perform daily watering task, such as watering a garden, lawn or washing a vehicle is difficult and therefore, one of the disadvantages of conventional rain barrels.

Yet another disadvantage of conventional rain barrel is the need to transfer water from the rain barrel to watering devices such as watering cans, already well known in the market. The watering cans have typically on an average around 10 liters of storage volume. Considering the weight of water, the volume of water the watering can may hold is limited before the average user is precluded from transporting it by the weight of the device. The weight may not only inhibit the distance the user can travel from the rain barrel, but also the volume of water the average user can use for carrying out tasks while carrying the watering can, and thereby forcing the user to make several trips back and forth between the task and the rain barrel to refill the watering can.

Yet another disadvantage associated with the collection and distribution of rainwater by the conventional rain barrel is the use of a conventional garden hose to distribute the collected rainwater from the rain barrel. This is typically accomplished by attaching a side-mounted spigot on the rain barrel to facilitate the distribution of water. As the water from the rain barrel is pumped, the water level in the rain barrel drops, and as the level of water in the rain barrel decreases, it lessens the efficiency of water distribution via hose.

An additional problem with water distribution via garden hose is the limitations associated with the hose length. The user is limited to the distance he can travel on his property and the space to store said hose of varying lengths. Hoses also present the user with the need to store long lengths of hose in typically close proximity to the rain barrel.

Yet another disadvantage associated with current rain barrel technology is that the side-mounted spigot typically found on most rain barrels does not allow for complete drainage of water out of the rain barrel. In instances where the water harvesting device comprises a barrel, for example, the spigot is normally mounted a few inches above a bottom portion of the barrel to allow access to the spigot. Consequently, water will accumulate below the release point of the spigot.

Yet another disadvantage of conventional rain barrel technology relates to the limits on pressure required to draw the water from a rain barrel. Without mounting an expensive separate electrical or battery-powered pump, existing devices only have enough pressure to empty the water into a bucket or garden area below the water line or spigot. Without an electrical or other pumping system, there may be the need to raise the barrel to a significant height which presents additional costs and effort of constructing a base suitable for achieving stable water pressure. For example, raising the barrel 2.3 feet off the ground will add approximately 1 PSI. It is generally accepted that consistent, stable water pressure that meets the average garden's needs is water pressure of 10 PSI. To accomplish 10 PSI, the rain barrel needs to be 23.1 feet above the garden, which may not be practical for the average user.

In view of the foregoing, it would be useful to have a new, improved rain barrel that more efficiently facilitates irrigation or other outdoor uses that is unheeded by the limitations described above. Therefore, there is a need for a newly functioning and improved rain barrel that possesses the characteristics that would better aid in the extraction and distribution of water from the rain barrel to permit the user to more effectively utilize water from the device to overcome the delivery limitations of distance, weight, labour intensity, water pressure loss and slow distribution impediments.

### SUMMARY

An embodiment provides an apparatus for collecting and dispensing fluid. The apparatus comprises of a main barrel and a secondary unit. The main barrel comprises of a primary reservoir for collecting and storing fluid and the secondary unit comprises of a secondary reservoir for storing fluid that is received from the main barrel. The main barrel defines a space for receiving the secondary unit, wherein the secondary unit is configured to be operably docked in the space defined by the main barrel. The secondary unit when docked to the main barrel, the main barrel and the secondary unit are coupled to receive fluid from the primary reservoir of the main barrel into the secondary reservoir of the secondary unit.

### BRIEF DESCRIPTION OF DRAWINGS

Embodiments are illustrated by way of example and not limitation in the figures of the accompanying drawings, in which like references indicate similar elements and in which:

FIG. 1A illustrates a side view of an apparatus 100, in accordance with an embodiment;

FIG. 1B illustrates a side view of the apparatus 100 depicting a secondary unit 104 docked within a main barrel 102, in accordance with an embodiment;

FIG. 2A illustrates a side view of the main barrel 102, in accordance with an embodiment;

FIG. 2B illustrates a rear view of the main barrel 102, in accordance with an embodiment;

FIG. 3A illustrates a side view of the secondary unit 104, in accordance with an embodiment;

FIG. 3B illustrates a rear view of the secondary unit 104, in accordance with an embodiment;

FIG. 4 illustrates a front view of the secondary unit 104 depicting part of the manual pump setup, in accordance with an embodiment;

FIG. 5A illustrates a rear view of the secondary unit 104 with its pull handle in retracted position, in accordance with an embodiment;

FIG. 5B illustrates a rear view of the secondary unit 104 with its pull handle in extended position, in accordance with an embodiment;

FIG. 6A illustrates a side view of the apparatus 100 when the secondary unit 104 is docked in the main barrel 102, in accordance with an embodiment; and

FIG. 6B illustrates a side view of the apparatus 100 when the secondary unit 104 is undocked from the main barrel 102, in accordance with an embodiment.

FIG. 7A illustrates a perspective view of an alternate embodiment 700 comprising of a first unit 702 and a second unit 704;

FIG. 7B illustrates a front view of the first unit 702 and second unit 704 depicting construction of the first unit 702 and the second unit 704; and

FIG. 7C illustrates a perspective view of the first unit 702 and second unit 704 depicting construction of the first unit 702 and the second unit 704.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

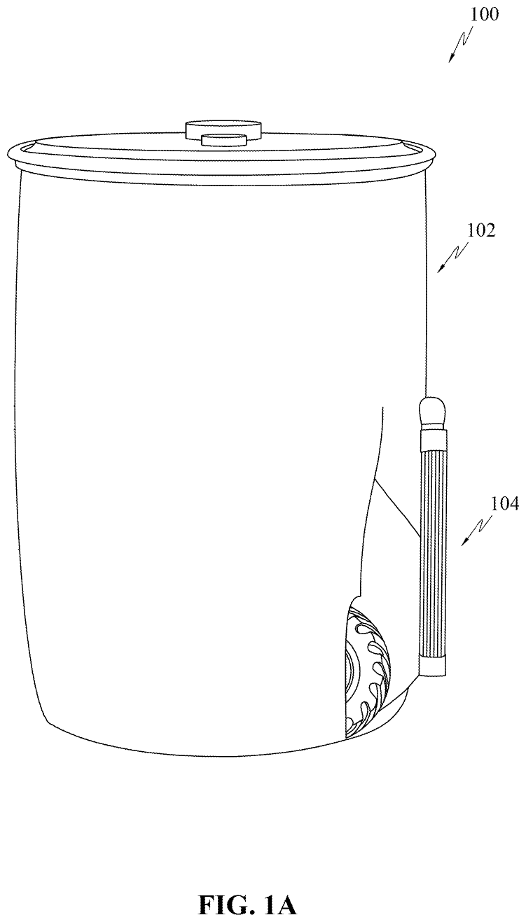

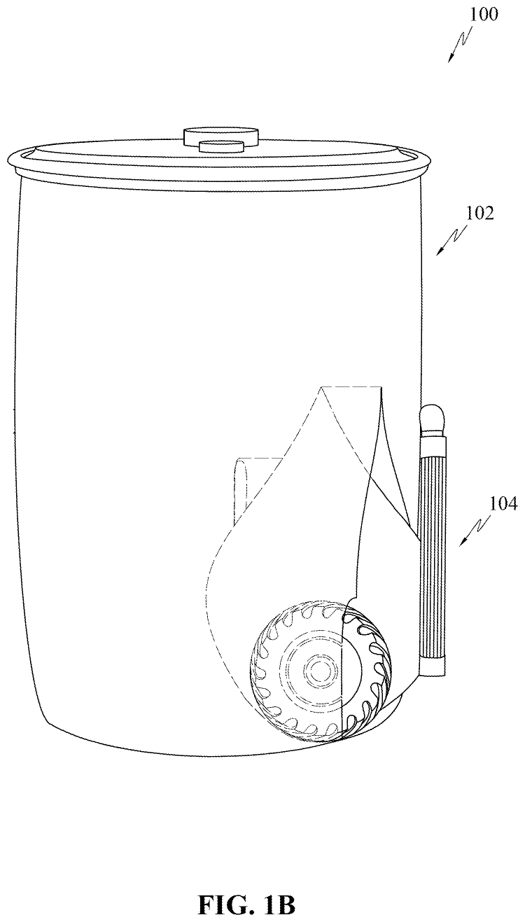

Referring to FIGS. 1A-1B, an apparatus 100 for collecting and dispensing fluid is disclosed. The apparatus 100 for collecting and dispensing fluid comprises of a main barrel 102 and a secondary unit 104, in accordance with an embodiment. The secondary unit 104 may be configured to be operably docked and undocked with the main barrel 102. When the secondary unit 104 is docked to the main barrel 102, a connection may be formed between the secondary unit 104 is docked to the main barrel 102 thereby enabling fluid flow from the main barrel 102 to the secondary unit 104. When the secondary unit 104 is undocked from the main barrel 102, fluid flow from the main barrel 102 to the secondary unit 104 is prevented. The secondary unit 104 may be configured to be operated independently when undocked from the main barrel 102.

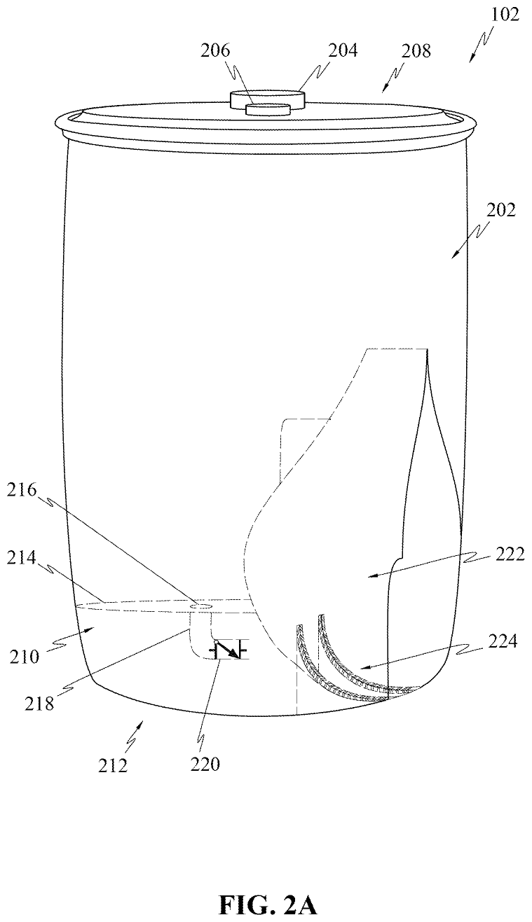

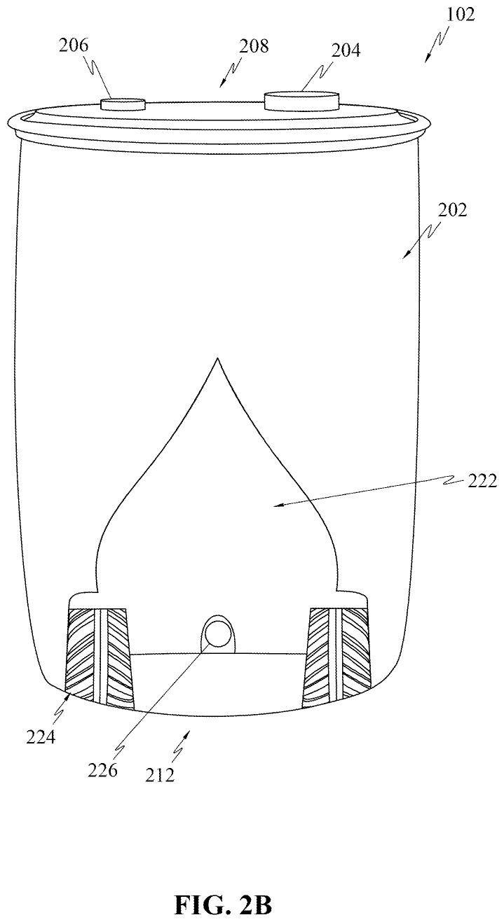

Referring to FIGS. 2A-2B, structural configuration of the main barrel 102 is disclosed. The main barrel 102 comprises of a primary reservoir 202 for collecting and storing of fluid. The main barrel 102 may be provided with a main barrel first inlet 204 towards one side of an upper end 208 of the main barrel 102 and a main barrel first outlet 206 on another side of the upper end 208 (refer FIG. 2B). The main barrel first inlet 204, when connected to an external fluid source, may be configured to receive fluid from the external fluid source. For example, an external fluid source can be, but not limited to, a typical residential or commercial rain gutter setup (not shown in figures). One end of the main barrel first inlet 204 that may be exposed may be configured to be connected to the external fluid source to receive fluid. Another end of the main barrel first inlet 204 opposite to the side exposed may be configured to be connected to the primary reservoir 202 within the main barrel 102 such that the fluid received from the external source is collected and transferred to the primary reservoir 202 to store the fluid.

In an embodiment, the main barrel first outlet 206 may be configured to function as a fluid overflow exit, wherein, when the fluid in primary reservoir 202 reaches maximum capacity, excess fluid may exit the main barrel 102 through the main barrel first outlet 206 thereby allowing to maintain fluid pressure inside the primary reservoir 202 of the main barrel 102.

In an embodiment, the main barrel first inlet 204 may be, but not limited to, larger than the main barrel first outlet 206. The larger main barrel first inlet 204 may allow faster filling of the primary reservoir 202.

In an embodiment, a false bottom space 210 may be provided towards one side of a lower end 212 of the main barrel 102 (refer FIG. 2A). The false bottom space 210 may be configured to house piping. A false bottom space ceiling 214 may be provided that may be configured to separate the primary reservoir 202 and the false bottom space 210 of the main barrel 102. The portion above the false bottom space 210 defines the primary reservoir 202.

In an embodiment, the false bottom space ceiling 214 may be provided with a main barrel second outlet 216. The false bottom space ceiling 214 may be provided at a slight angle, angled towards the main barrel second outlet 216 such that the fluid from the primary reservoir 202 is allowed to freely flow towards the main barrel second outlet 216 under gravity. The main barrel second outlet 216 may extend towards the false bottom space 210.

In an embodiment, the main barrel 102 comprises of a first hose 218 and a first check valve 220 (refer FIG. 2A). The first hose 218 may be configured to be coupled to the main barrel second outlet 216. The first hose 216 may be in turn configured to be operably coupled to the first check valve 220 to form a connection between the main barrel second outlet 216, the first hose 218 and the first check valve 220. Both the first hose 218 and the first check valve 220 may be disposed within the false bottom space 210 towards the lower end 212 of the main barrel 102.

In an embodiment, the first check valve 220 may be, but not limited to, one-way valve, ball valve, foot valve, spring activated valve or a quick connect valve. The first check valve 220 may be configured to allow fluid flow in a single direction.

In an embodiment, the main barrel 102 may define a space 222 on one side within the main barrel 102. The space 222 defined may be configured to receive the secondary unit 104, such that the secondary unit 104 may be docked and undocked in/from the defined space 222. The space 222 defined by the main barrel 102 may be provided with a pair of ramps 224, the purpose of which will be discussed later. The space 222 for receiving the secondary unit 104 may be defined in a way that the defined space 222 extends inwardly towards the primary reservoir 202, in a way that the primary reservoir 202 may be formed around the defined space 222 within the main barrel 102. The defined space 222 may be provided with an opening 226 towards lower end 212 (refer FIG. 2B), the purpose of which will be discussed later. The opening 226 may be provided in a way that it longitudinally aligns with the first check valve 220 of the main barrel 102.

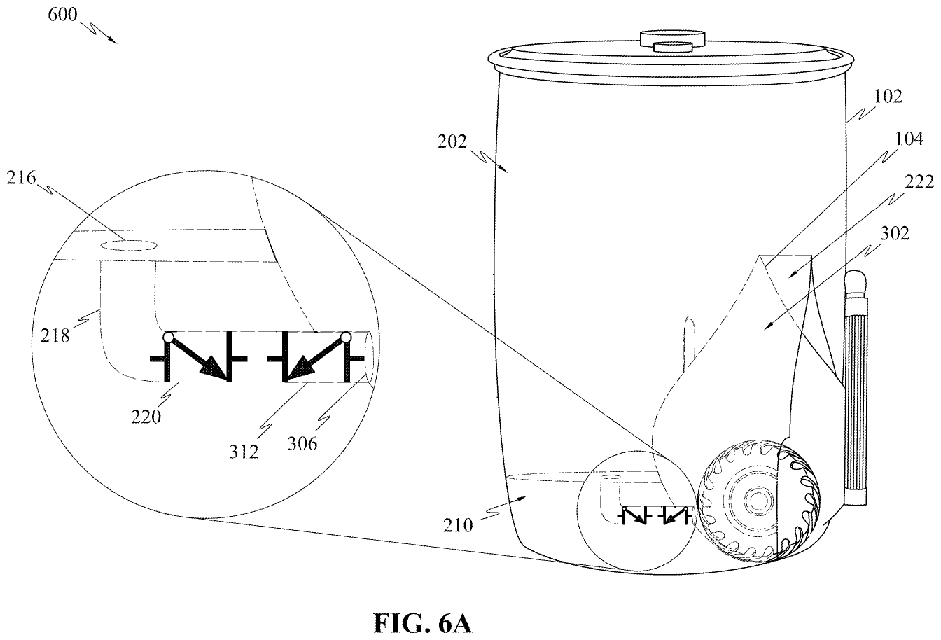

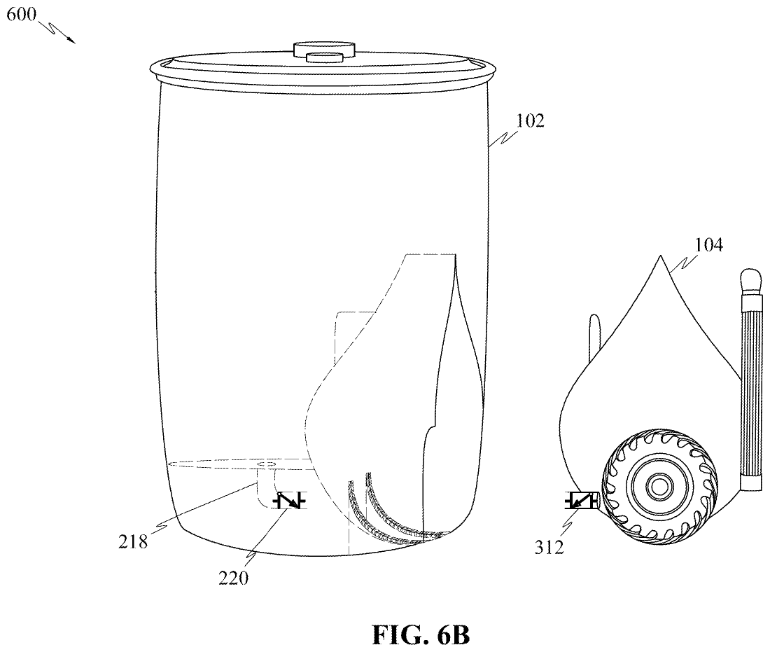

In an embodiment, the space 222 defined by the main barrel 102 for docking of the secondary unit 104 may be profiled in a manner that the secondary unit 104 may be received within the defined space 222 when docked. For example, referring to FIG. 6B, the secondary unit 104 may have a water drop profile which may be similar to the profile of the space 222 defined by the main barrel 102.

In an embodiment, a main barrel 102 may define a space that may comfortably receive a secondary unit 104, when docked.

In an embodiment, the main barrel 102 may be provided with a pressure regulator and a fluid level sensing unit (both not shown in figures). The pressure regulator may be configured to continuously monitor fluid pressure within the primary reservoir 202. The fluid level sensing unit may be provided with a sensor and a notification module. The sensor may be configured to detect the level of the fluid and the notification module may be configured to alert a user of the fluid level in the primary reservoir 202. The notification module may be, but not limited to, an alarm, a LED notification, a display unit, or a text notification sent to a user mobile device, among others.

In an exemplary embodiment, the main barrel 102 may be provided with a solenoid operated pump (not shown in figures) to deliver fluid from the main barrel 102 to the secondary unit 104. The solenoid operated pumps may include one or more check valves or other backflow preventer that may prevent water from flowing in a reverse direction from the secondary unit 104 to the main barrel 102.

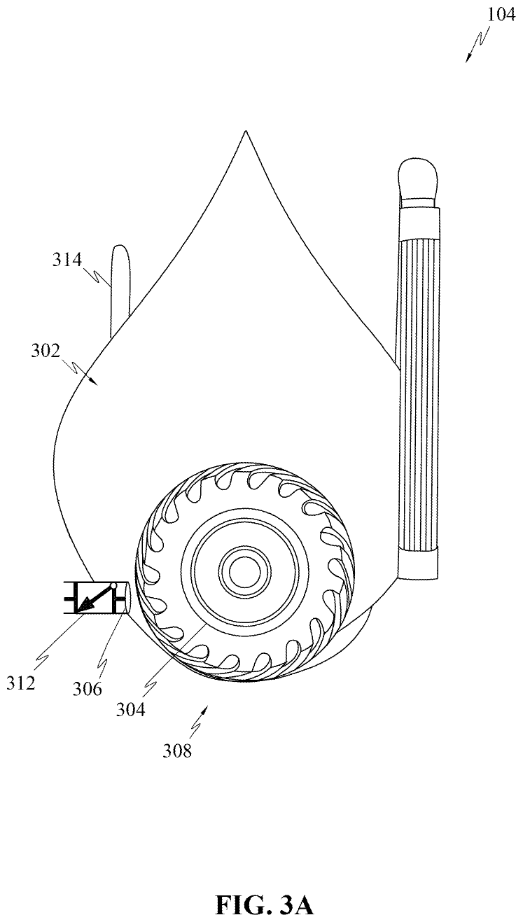

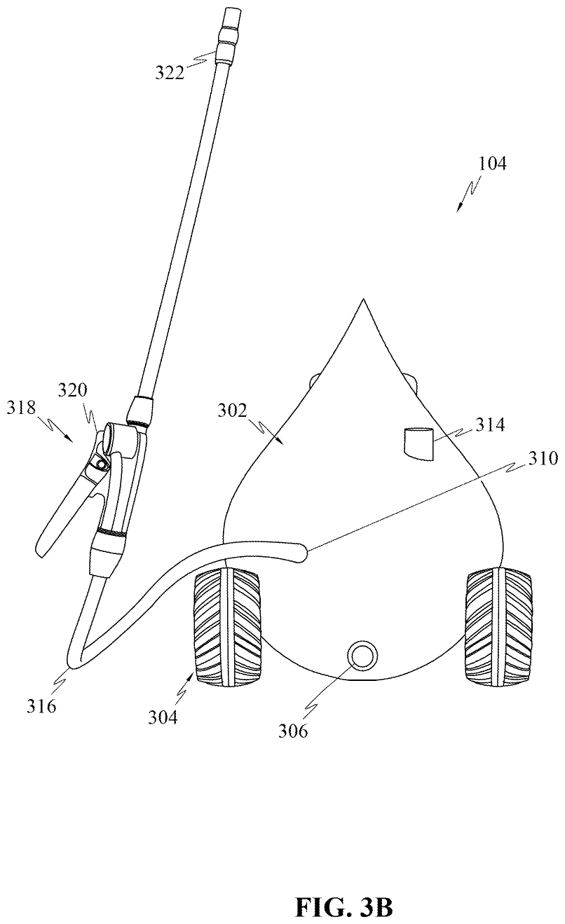

Referring to FIGS. 3A-3B, the secondary unit 104 is disclosed in accordance with an embodiment. The secondary unit 104 may be configured to receive fluid from the main barrel 102. The secondary unit 104 may define an external profile such that the secondary unit 104 is comfortably and operably docked and undocked from the main barrel 102. The secondary unit 104 may be configured to be independently operated when undocked from the main barrel 102. The secondary unit 104 may be provided with adequate components for its independent working.

In an embodiment, the secondary unit 104 comprises of a secondary reservoir 302 for storing fluid received from the primary reservoir 202 of the main barrel 102. The secondary reservoir 302 may be smaller in capacity by volume as compared to the primary reservoir 202. The secondary reservoir 302 may be configured to receive fluid from the primary reservoir 202 of the main barrel 102.

In an embodiment, the secondary unit 104 may comprise of a pair of wheels 304. The pair of wheels 304 may allow easy mobility of the secondary unit 104, when undocked from the main barrel 102. The pair of wheels 304 provides a user ease of mobility when docking, undocking or transporting the secondary unit 104 to a desired location. The pair of wheels 304 may be provided on the secondary unit 104 in a way that the pair of wheels 304 are received over the pair of ramps 224 provided within the space 222 defined in the main barrel 102 when the secondary unit 104 is docked to the main barrel 102.

In an embodiment, the secondary unit 104 comprises of a secondary unit first inlet 306 provided towards a lower end 308 of the secondary unit 104, a secondary unit first outlet 310, a second check valve 312 and a pressure regulator 314. The pressure regulator 314 may be configured to continuously monitor the fluid pressure in the secondary reservoir 302. The secondary unit first inlet 306 may be coupled to the second check valve 312. The secondary unit first inlet 306 and the second check valve 312 may be provided such that they align with the opening 226 provided towards lower side of the space 222 defined by the main barrel 102, when the secondary unit 104 is docked within the main barrel 102. The second check valve 312 may extend into the opening 226 into the false bottom space 210 such that the second check valve 312 of the secondary unit 104 and the first check valve 220 of the main barrel 102 are precisely aligned and are coupled when the secondary unit 104 is docked with the main barrel 102 thereby allowing fluid transfer from the main barrel 102 to the secondary unit 104. The secondary unit first outlet 310 may be provided for dispensing the fluid stored in the secondary reservoir 302 in the secondary unit 104.

In an embodiment, the second check valve 312 may be, but not limited to, one-way valve, ball valve, foot valve, spring activated valve or quick connect valve. The second check valve 312 may be configured to allow fluid flow in a single direction.

In an embodiment, the secondary unit 104 comprises of a hose 316 and a sprayer assembly 318. The sprayer assembly 318 comprises of a sprayer lever 320 and a sprayer nozzle 322. One end of the hose 316 may be connected to the secondary unit first outlet 310 and another end of the hose 316 may be connected to the sprayer assembly 318, thereby forming a connection and having a continuous connection between the secondary unit 104 and the sprayer assembly 318. The hose 316 may be a flexible pipe, or any know pipe known in the industry that may be capable of withstanding higher fluid pressure.

In an embodiment, the secondary unit 104 may be provided with a pump (not shown in figures), wherein the pump may be configured to pump the fluid stored in the secondary reservoir 302 to the sprayer nozzle 322 through the hose 316 connected to the secondary unit first outlet 310. The pump may be, but not limited to, an electrical pump. The secondary unit may be provided with a power source to power the pump. The power source may be, but not limited to, a rechargeable battery integrated within the secondary unit 104.

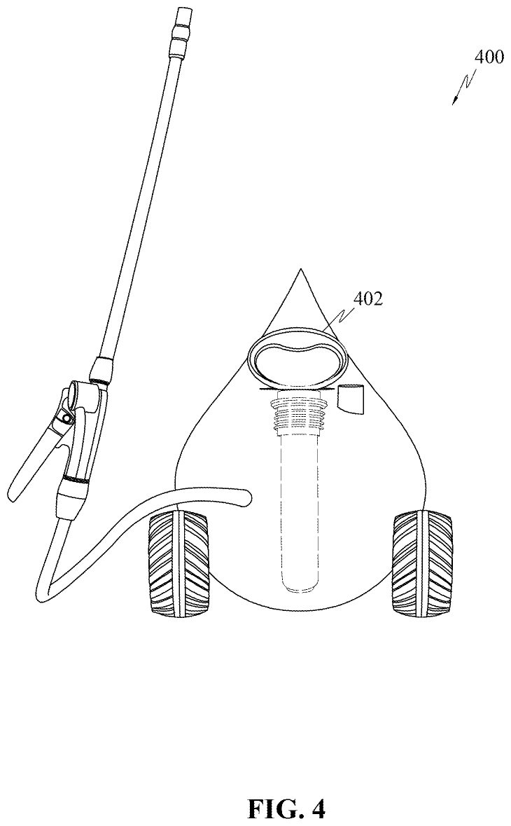

Referring to FIG. 4, in an alternate embodiment, secondary unit 400 may be provided with a manually operated pump setup for pumping fluid from secondary reservoir. The setup may comprise of, but not limited to, a conventional lever 402 coupled with a piston arrangement (not shown) for pumping of fluid from the secondary reservoir to sprayer assembly for dispensing of the fluid.

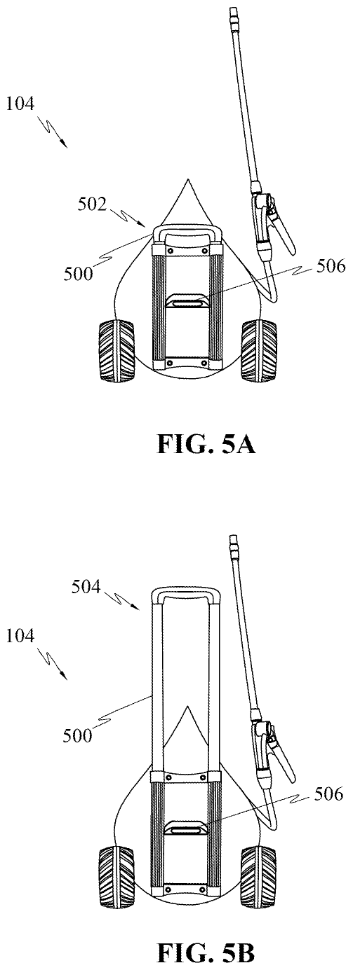

Referring to FIGS. 5A-5B, a pull handle setup 500 may be provided on one side of the secondary unit 104, in accordance with an embodiment. The pull handle setup 500 may be, but not limited to, a telescopic handle capable of being extended 504 and retracted 502 as per convenience. The pull handle 500 may allow a user to manoeuvre the secondary unit 104. The secondary unit 104 when undocked from the main barrel 102, may be transported to required places with the help of the pull handle 500 and the pair of wheels 304 provided on the secondary unit 104. Once the secondary unit 104 reaches the required place, the pull handle 500 may be retracted 502.

In an embodiment, the secondary unit 104 may be provided with an additional handle 506. The additional handle 506 may be provided on the same side as that of the pull handle 500. The additional handle 506 may be provided for docking or undocking of the secondary unit 104 from the main barrel 102. A user may utilise the additional handle 506 provided to pull or push the secondary unit 104 out or into the space 222 defined by the main barrel 102.

Having provided structural details of the main barrel 102 and the secondary unit 104, working of the apparatus 100 shall now be discussed in greater detail.

Referring to FIGS. 1A-6B, the apparatus 100 for collecting and dispensing fluid is disclosed. The apparatus 100 comprises of the main barrel 102 comprising of a primary reservoir 202 configured to collect and store fluid received from an external fluid source, and the secondary unit 104 comprising of the secondary reservoir 302 configured to receive fluid from the primary reservoir 202 when the secondary unit 104 is docked to the main barrel 102 and connected to the primary reservoir 202.

In an embodiment, the secondary unit 104 may be configured to be operably received by the main barrel 102 and to be docked to the main barrel 102. The space 222 defined by the main barrel 102 may be configured to receive the secondary unit 104. While docking the secondary unit 104, it is important to ensure that the secondary unit 104 is in precise alignment with the main barrel 102. To achieve a precisely aligned fit, the secondary unit 104 may be piloted via the pull handle 500 towards the main barrel 102 where the pair of wheels 304 of the secondary unit 104 are directed towards the pair of ramps 214 on the main barrel 102 for precise alignment. As the secondary unit 104 docks with the main barrel 102, the second check valve 312 may be configured to mechanically couple with the first check valve 220 (refer FIG. 6A). The first check valve 220 and the second check valve 312, when coupled, may be mechanically forced into an open position, thereby allowing the fluid contained in the main barrel 102 to flow into the secondary unit 104. Fluid will flow into the secondary unit 104 until it reaches its maximum volume capacity.

In an embodiment, the space 222 defined by the main barrel 102 and the secondary unit 104 may be provided with, but not limited to, a provision for snap fit, wherein seams or wall edges (not shown in figures) of the secondary unit 104 may contain a small protrusion (hook, bead or bump) which deflects during assembly to catch in a depression located in the corresponding mating sections of the wall edges of the space 222 defined by the main barrel 102 forming a uniform fit that can be separated.

The secondary unit 104, when docked within the space defined 222 by the main barrel 102, may be configured to be coupled with the main barrel 102. The second check valve 312 of the secondary unit 104 aligns with the opening 226 provided in the main barrel 102 that opens up to the false bottom space 210 thereby allowing the second check valve 312 to in turn align with the first check valve 220 of the main barrel 102. Further, the first check valve 220 and the second check valve 312 are coupled, when the secondary unit 104 is docked. The secondary unit 104, when connected with the main barrel 102, is configured to receive fluid from the primary reservoir 202 of the main barrel 102.

In an embodiment, the first check valve 220 of the main barrel 102 may operate as a conduit point through which the fluid is transferred one way from the primary reservoir 202 of the main barrel 102 to the secondary reservoir 302 of the secondary unit 104, but does not allow the fluid to escape the main barrel 102 when the secondary unit 104 is undocked.

Similarly, the second check valve 312 of the secondary unit 104 operate as a conduit point through which the fluid is transferred one way from the primary reservoir 202 of the main barrel 102 to the secondary reservoir 302 of the secondary unit 104, but does not allow the fluid to escape the secondary reservoir 302 when the secondary unit 104 is undocked.

In an embodiment, the transfer of fluid occurs from the primary reservoir 202 of the main barrel 102 to the secondary reservoir 302 of the secondary unit 104 when the second check valve 312 located at the lower side of the secondary unit 104 is connected with the first check valve 220 of the main barrel 102, wherein upon connection of the check valves (220, 312), the check valves (220, 312) are operationally engaged into an open position thereby allowing the fluid stored in the main barrel 102 to be transferred to the secondary unit 104 i.e., transfer of fluid from a region at higher fluid pressure to a region at lower fluid pressure.

In an embodiment, when the secondary reservoir 302 of secondary unit 104 reaches its maximum volume capacity, the secondary unit 104 may be undocked from the main barrel 102, and in doing so, the check valves (220, 312) provided on both the secondary unit 104 and the main barrel 102, respectively operationally close thereby securing the liquid in the respective reservoirs (202, 302) of the secondary unit 104 and main barrel 102.

In an embodiment, the second check valve 312 of the secondary unit 104 may be configured to receive fluid to the secondary unit 104 from the main barrel 102, but may be configured to resist the flow of fluid in opposite direction.

Once the fluid from the primary reservoir 202 of the main barrel 102 is transferred to the secondary reservoir 302 of the secondary unit 104 and the secondary reservoir 302 is filled completely, the secondary unit 104 may be undocked from the main barrel 102 and may be utilised to transport the fluid to desired location for necessary application.

In an embodiment, the user may pull on the additional handle 506 to undock the secondary unit 104 from the main barrel 102. As the undocking commences, the first check valve 220 and the second check valve 312 disengage and automatically return from an open position to a closed position to prevent the flow of fluid from both the main barrel 102 and the secondary unit 104 through the check valves. The secondary unit 104 may be then ready to be physically transported to pump water where needed. The telescopic pull handle 500 may be extended 504 to open position so that the user may utilize the pull handle 500 to transport the secondary unit 104.

In an embodiment, the apparatus 100 may be provided with a single secondary unit 104 or plurality of secondary units. Advantage of having plurality of secondary units is that one among the plurality of secondary units may be configured to be operably received by the space 222 defined by the main barrel 102 thereby allowing continuous refilling of the secondary units 104 from the main barrel 102. When one of the secondary units is refilled, another secondary unit 104 may be docked in the main barrel 102 for refill thereby limiting time wastage.

In an embodiment, the secondary unit 104 may be similar to conventional pump sprayers known in the art, with the exception of provision of the second check valve 312 that are typically used for dispensing a wide variety of fluids such as water, insecticides, herbicides, degreasers, stains, and paints, among others.

In an embodiment, the apparatus 100 may find function in, but not limited to, numerous liquids requiring transfer, including, but not limited to barrels associated with wine, spirits, beer, cider, paint and chemicals, and liquid cleaning products.

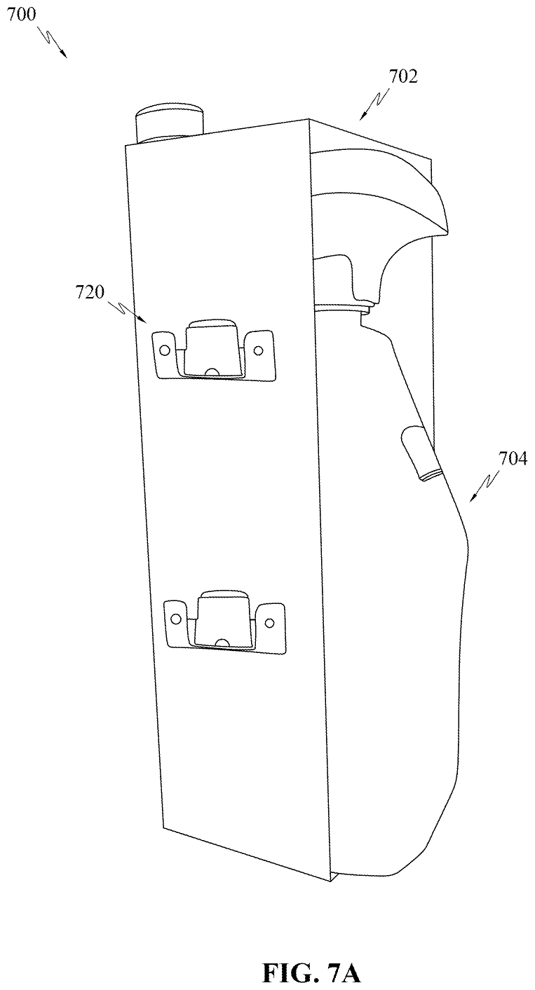

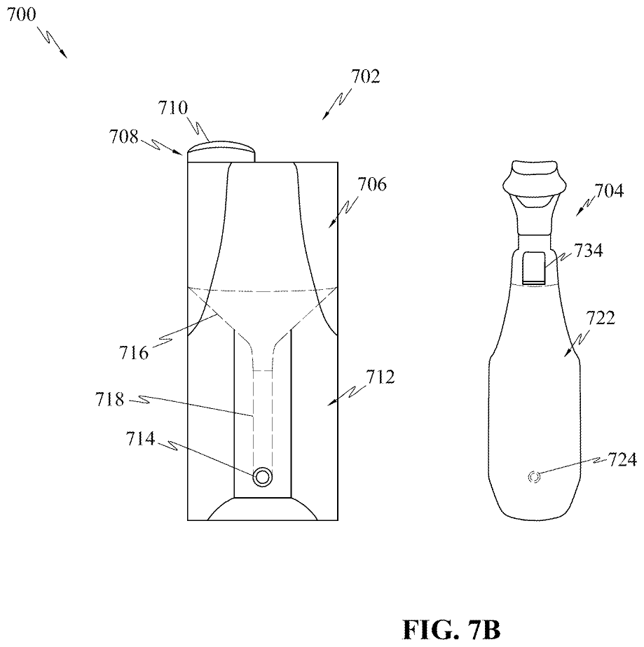

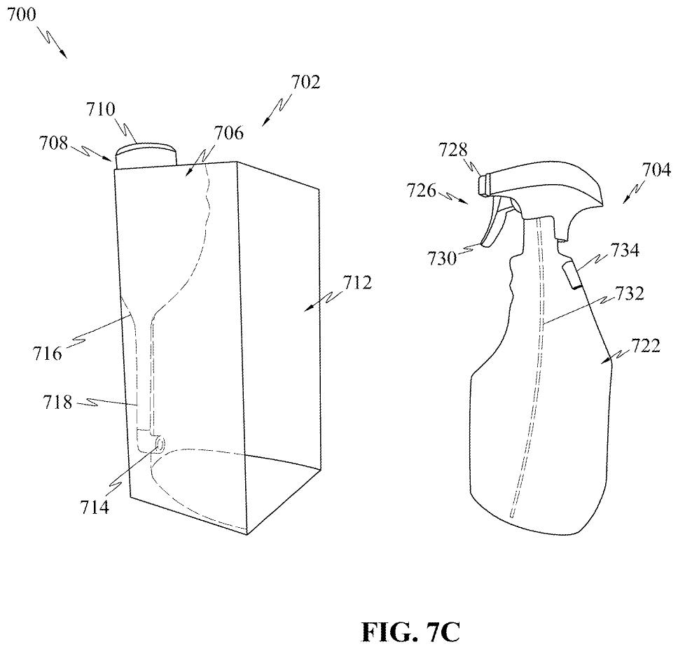

Referring to FIGS. 7A-7C, an apparatus 700 with a first unit 702 and a second unit 704 may be provided, in accordance with an embodiment. The second unit 704 may be configured to be detachably connected to the first unit 702 for receiving fluid from the first unit 702. The first unit 702 may be provided for refilling the second unit 704, when the second unit 704 is received in the first unit 702. The first unit 702 may be provided with a first reservoir 706 for collecting and storing of fluid received from an external fluid source.

The first unit 702 may be provided with a first inlet 708 towards an upper side of the first unit 702. The first inlet 708 may be provided for receiving fluid from the external fluid source. The first inlet 708 may be provided with a cap 710 that is configured to close the first inlet 708 when not in use. The first unit 702 may define a cavity 712 on one side. The cavity 712 may be configured to receive at least a part of the second unit 704 in a way that the second unit 704 is connected to the first unit 702 to transfer fluid stored in the first unit 702 to the second unit 704. The first unit 702 may be provided with a one-way valve 714 towards a lower side of the first unit 702. The one-way valve 714 may be configured to allow fluid to flow in a single direction and restrict the flow of fluid in opposite direction. The first unit 702 comprises of a funnel shaped conduit 716 disposed below the first reservoir 706. The first unit 702 may be provided with a first connecting pipe 718 connecting the conduit 716 to the one-way valve 714. At least one connecting member 720 may be provided on opposite sides of lateral surface of the first unit 702. The connecting members 720 may be provided for consecutive connecting of multiple first units 702 thereby forming a continuous group of first units (not shown in figures). The bottom of the funnel shaped reservoir may be a false bottom. The first unit could contain a solenoid operated pump, such that a user could press a button and get a certain amount of fluid transferred into the second unit.

The second unit 704 comprises of a second reservoir 722 for storing fluid received from the first reservoir 706 of the first unit 702. The second unit 704 may be provided with a second inlet 724 towards its lower side for receiving fluid from the first unit 704, when the second unit 704 is connected to the first unit 702. The second unit 704 may be provided with a fluid dispensing setup 726 (refer FIG. 7C) towards upper side of the second unit 704. The fluid dispensing setup 726 comprises of a dispensing nozzle 728 and a dispensing trigger 730, and a pipe 732 configured to be connected to the dispensing setup 726, wherein free end of the pipe 732 may extend within the second reservoir 722 towards lower side of the second unit 704. The pipe 732 may be configured to transfer fluid from the second reservoir 722 to the dispensing nozzle 728 when the dispensing trigger 730 is actuated. The dispensing unit 726 may be, but not limited to, manually operated, wherein the dispensing trigger 730 may act as a manually operated pump to pump the fluid from the second reservoir 722.

The second inlet 724 of the second unit 704 may be provided with a one-way valve (not shown in figures), wherein the one-way valve may be configured to allow fluid flow from the first unit 702 to the second unit 704 whereas restrict the fluid flow in opposite direction. This allows the second unit 704 to be used independently when disconnected from the first unit 702.

The second unit 704 may be provided with an orifice 734 towards upper side of the second unit 704. The orifice 734 may be provided for receiving any additional fluid directly into the second unit 704.

The second unit 704 when received in the cavity 712 defined by the first unit 702, the one-way valves provided on both the first unit 702 and the second unit 704 may be mechanically connected thereby automatically switching the valves in open position to allow fluid to flow from the first unit 702 to the second unit 704. Upon refilling, the second unit 704 may be disconnected from the first unit 702, wherein the one-way valves are automatically turned to closed position, when disconnected thereby restricting the flow of fluid from the first unit 702 to the second unit 704. Upon refilling of the second unit 704, the second unit may be undocked from the first unit 702 to be used individually.

It shall be noted that the processes described above are described as sequence of steps; this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus, the scope of the invention should be determined by the appended claims and their legal equivalents rather than by the examples given.

What is claimed is:

1. An apparatus for collecting and dispensing fluid, the apparatus comprising:
a main barrel comprising a primary reservoir for collecting and storing fluid;
a secondary unit comprising of a secondary reservoir for storing fluid;
wherein,
the main barrel defines a space for receiving the secondary unit; and
the secondary unit is configured to be operably docked in the space defined by the main barrel,
wherein when the secondary unit is docked to the main barrel, the main barrel and the secondary unit are coupled to receive fluid from the primary reservoir of the main barrel into the secondary reservoir of the secondary unit.

2. The apparatus as claimed in claim 1, wherein the secondary unit is profiled in a manner that the secondary unit is received within the space of the main barrel thereby allowing operable docking of the secondary unit in the main barrel.

3. The apparatus as claimed in claim 1, wherein the secondary unit, when docked, is configured to be snap fit into the main barrel.

4. The apparatus as claimed in claim 1, wherein the secondary unit, when undocked from the main barrel, is configured to be disconnected from the main barrel.

5. The apparatus as claimed in claim 4, wherein the secondary unit is configured to be independently operated from the main barrel, when undocked from the main barrel.

6. The apparatus as claimed in claim 1, wherein the main barrel further comprises:
a main barrel first inlet for receiving fluid input;
a main barrel first outlet for fluid to exit the main barrel in case of an overflow;
a main barrel second outlet, provided towards a lower side of the main barrel, for fluid outflow into the secondary reservoir from the primary reservoir of the main barrel;
a first hose coupled to the main barrel second outlet;
a first check valve engaged with the first hose; and
a pair of ramps within the space defined by the main barrel.

7. The apparatus as claimed in claim 6, wherein the secondary unit comprises of:
a pair of wheels for mobility of the secondary unit, wherein the pair of wheels are configured to be received by the pair of ramps provided in the space defined by the main barrel; and
a pressure regulator for measuring pressure of the fluid stored in the secondary reservoir.

8. The apparatus as claimed in claim 6, wherein the main barrel first inlet is configured to be connected to an external fluid source to receive fluid.

9. The apparatus as claimed in claim 6, wherein the first check valve is any one of one-way valve, ball valve, foot valve, spring activated valve or quick connect valve.

10. The apparatus as claimed in claim 6, wherein the secondary unit further comprises:
a secondary unit first inlet, provided towards a lower side of the secondary unit, for receiving fluid from the primary reservoir of the main barrel;
a second check valve coupled to the secondary unit first inlet; and
a secondary unit first outlet for dispensing fluid stored in the secondary reservoir.

11. The apparatus as claimed in claim 10, wherein, when the secondary unit is docked to the main barrel, the first check valve is operably coupled with the second check valve to keep the first check valve and the second check valve in an open position thereby enabling the fluid from the primary reservoir to flow into the secondary reservoir.

12. The apparatus as claimed in claim 10, wherein, when the secondary unit is undocked from the main barrel, the first check valve disengages from the second check valve and the first check valve and the second check valve switches to a closed position thereby preventing the fluid exiting the primary reservoir and the secondary reservoir respectively.

13. The apparatus as claimed in claim 10, wherein the second check valve is any one of one-way valve, ball valve, foot valve or spring activated valve or quick connect valve.

14. The apparatus as claimed in claim 10, wherein the secondary unit comprises:
a hose coupled to the secondary unit first outlet; and
a sprayer assembly coupled to the hose, wherein the sprayer assembly comprises:
a sprayer lever; and
a sprayer nozzle.

15. The apparatus as claimed in claim 10, wherein the secondary unit comprises of a pump for dispensing the fluid out of the secondary reservoir.

16. The apparatus as claimed in claim 15, wherein the pump is a battery-operated electrical pump.

17. The apparatus as claimed in claim 15, wherein the secondary unit comprises a lever for manually operating the pump.

18. The apparatus as claimed in claim 7, wherein the secondary unit comprises:
a pull handle for moving the secondary unit; and
an additional handle for docking or undocking the secondary unit to the main barrel.
